(19) United States
(12) Patent Application Publication
(10) Pub. No.: US 2009/0217868 A1
(43) Pub. Date: Sep. 3, 2009

(54) DEVICE FOR SUPPLYING PASTY MATERIAL

(76) Inventor: Herve Caseteuble, Reze (FR)

Correspondence Address: PERMAN & GREEN, 425 POST ROAD, FAIRFIELD, CT, 06824, US

(21) Appl. No.: 11/718,544

(22) PCT Filed: Oct. 25, 2005
(86) PCT No.: PCT/FR2005/050893

§ 371 Date: May 18, 2009

(30) Foreign Application Priority Data
Nov. 3, 2004 (FR) 0452508

(51) Int. Cl. B05C 11/00; B08B 9/093; B08B 9/04

(52) U.S. Cl. 118/300; 134/22.18; 134/8

(57) ABSTRACT

The invention relates to a device for supplying pasty materials, said device comprising an end piece (1) for the supply of the material, and a coating nozzle (2). The inventive device is characterised in that the end piece comprises a channel (3) for the supply of the pasty material, said channel ending at a first end of the end piece in a central opening (4) of the nozzle (2).

This application is the National Stage of International Application No. PCT/FR2005/050893, International Filing Date, 25 Oct. 2005, which designated the United States of America, and which international application was published under PCT Article 21(2) as WO Publication No. WO 2006/048570 and which claims priority from French Application No. 0452508, filed Nov. 3, 2004.

The disclosed embodiments relate to a device for applying pasty material such as coating material and, in particular, putty, in particular for coating fastening devices.

Coating materials such as silicon or polyurethane putties are sticky materials, which, after polymerisation, become extremely difficult to remove from tools for the purpose of cleaning them.

Moreover, in the context of using these materials for coating fastening elements such as bolt heads, precise coating tools must be created in order to prevent the product from running, as well as to avoid appearance and sealing faults.

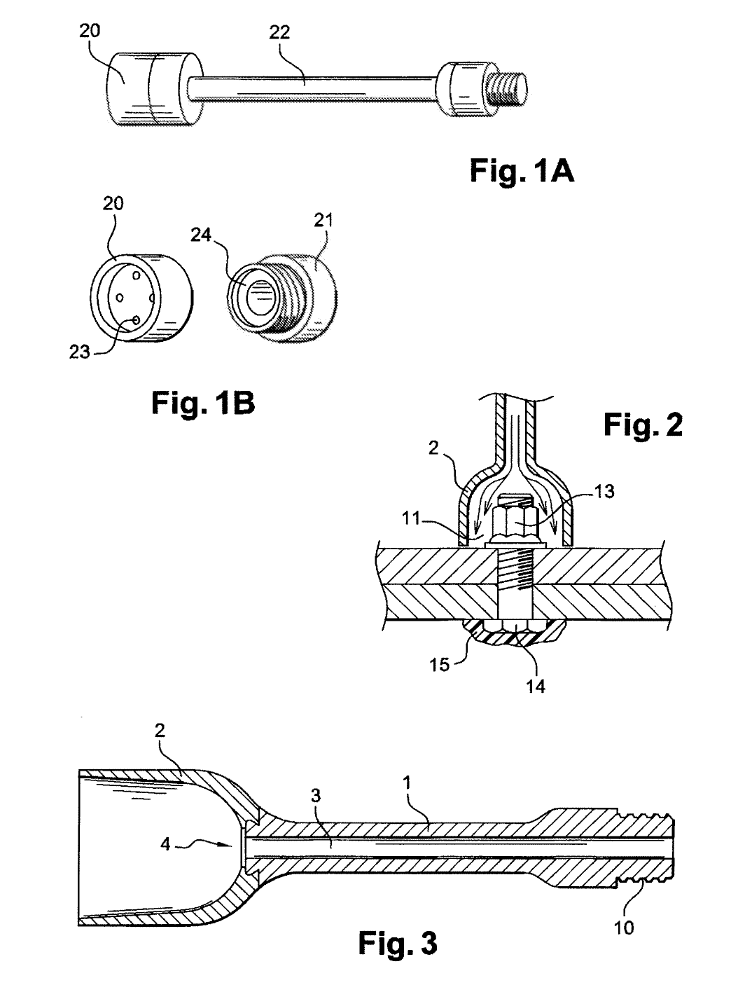

Known coating tools comprise devices with nozzles mounted on extruder guns, equipped with a recess consisting of a cylindrical cup equipped with product distribution holes. An example of an embodiment of the prior art is provided in FIGS. 1A and 1B for a cup with an approximate diameter of 15 millimetres comprising holes with an approximate diameter of 1 mm.

This cup is screwed onto a product supply tube, covering the fastener to be coated and then injecting the coating product onto the fastener.

In order to perform the isolation and coating of the fastening element, an operator covers the fastener with the nozzle and begins to inject the isolation material into the cup around the fastening element.

Cleaning the nozzles requires strong, expensive, polluting solvents and the use of brushes or other tools, in particular for unblocking the holes of the nozzles.

The nozzles are generally made from aluminium, are screwed onto fittings, also aluminium, and have dimensions that adapt to the fasteners to be coated, a specific nozzle corresponding to each fastener diameter.

The disclosed embodiment aims to provide coating nozzles that are easier to use than the nozzles of the prior art, which can be easily cleaned without using solvents and which are modular.

For this purpose, the disclosed embodiments principally relate to a device for applying pasty material comprising a material supply fitting and a coating nozzle, characterised in that the fitting comprises a material supply channel ending in a central opening of the nozzle.

More specifically, the nozzle is arranged in a bell shape around the central opening.

The use of a central opening allows easy cleaning of the device and the bell shape of the nozzle allows more homogenous distribution of the coating product.

Other features and advantages of the invention will be understood better from reading the following description of a non-limiting example of an embodiment of the invention made in reference to the appended drawings which show:

in FIGS. 1A and 1B: side perspective views of a fitting and a nozzle of the prior art;

in FIG. 2: a cross-section view of a nozzle according to the invention around a fastening device being coated;

in FIG. 3: a cross section view of a device according to the invention;

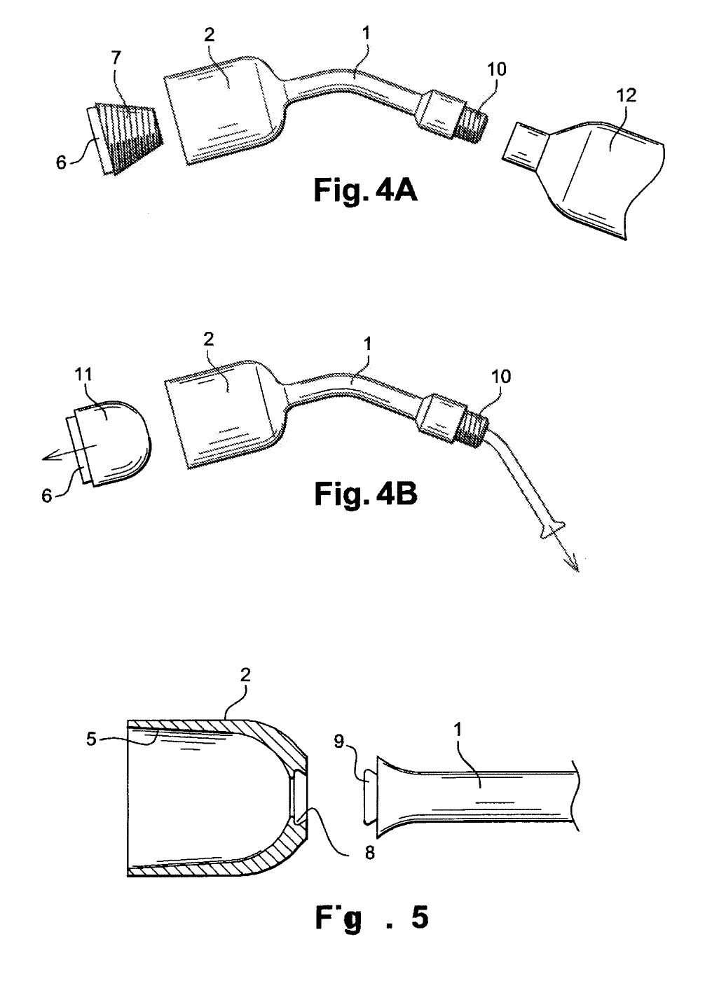

in FIGS. 4A and 4B: the device from FIG. 3 before and during cleaning;

in FIG. 5: a detail of the device from FIG. 3 showing the attachment of the nozzle on the filting.

The device for applying pasty material of the prior art comprises a fitting 22 onto which a nozzle in two parts 20, 21 is screwed, the first part 20 comprising a cup and holes 23 for distributing the pasty product, these holes leading to a distribution chamber 24 made in a second part of the nozzle and attached to the filting 22.

As in the prior art, the device according to the invention described in FIG. 3 comprises a product supply filting 1 and a coating nozzle 2.

Unlike the complex system of holes distributed under a cup and a distribution chamber of the prior art, a system which is at considerable risk of blocking, the device according to the invention comprises a nozzle 2 equipped with a central opening 4 supplying the pasty material onto the object to be coated and the fitting comprises a pasty material supply channel 3 ending at a first end of the filting in the central opening 4 of the nozzle 2.

The filting comprises a second end 10 for fastening onto an extruder gun 12 by screwing or any other means.

In order to coat objects such as screw 14 and nut 13 fastening devices, as shown in FIG. 2, the nozzle is shaped like a bell around the central opening 4.

Furthermore, the inner surface 5 of the nozzle is a continuous, smooth surface, thus allowing better distribution of the coating product than the nozzle of the prior art, which has a flat bottom and a cylindrical annular rim.

Furthermore, the coating product does not adhere to the continuous, smooth surface according to the invention.

From this same perspective, the nozzle and the fitting are advantageously manufactured from polyethylene, to which the pasty coating material and, in particular, a polyurethane putty will not adhere.

As shown in FIGS. 4A and 4B, the device according to the invention comprises, for cleaning purposes, according to a first variation, a cleaning tool comprising a stripping plug 6 which is inserted in the nozzle 2, the outer surface of which is adapted to adhere to the pasty material 11 once it is polymerised.

According to FIG. 4A, at the end of the coating process, the operator removes the fitting 1 from the extruder gun 12 and inserts the plug 6 into the nozzle.

The insertion of the plug causes a part of the product to flow back into the device through the second end of the fitting.

Once the product is polymerised, in order to clean the nozzle and the fitting, it is sufficient to remove the plug, which also removes the product lodged in the nozzle and to pull on the material residue sticking out from the end 10 of the fitting 1.

In order to improve its attachment to the material, the outer surface 7 of the stripping plug 6 according to the example is threaded so as to adhere to the pasty material 11.

According to this principle, the stripping plug 6 is inserted into the nozzle 2 before the polymerisation of the pasty material, the material is then allowed to polymerise and the material is extracted by removing the plug 6 from the nozzle.

Another cleaning method according to the invention consists, once the putty is polymerised, of connecting the end 10 of the fitting to a compressed air outlet, for example a compressed air stop valve. For this purpose, the air outlet comprises one end equipped with airtight means for fastening the end 10 of the fitting, in particular a tapping that complements the threaded end of the end 10 so as to cooperate with this end and create an airtight connection.

Once the end 10 is screwed onto the valve, the valve is opened so that compressed air blows into the fitting in order for the air to exert pressure on the polymerised putty and unstick it from the walls of the fitting and the nozzle, and the polymerised putty can then be removed by hand from the fitting and the nozzle, the putty, once unstuck, being easily removable from the nozzle by hand.

In the context of the invention, the fitting 1 is capable of receiving different sizes of nozzles 2 for coating different sizes of fasteners 13, 14.

To make it easier to replace the nozzles, the fitting 1 and the nozzles 2 are equipped with complementary snap-on attachment means 8, 9.

According to the example in FIG. 5, the snap-on attachment means 8, 9 comprise an annular rim 9 surrounding the first end of the fitting 1 and a circular groove around the central opening 4 of the nozzle 2 and it is sufficient to pull on the nozzle to detach it from the fitting, and then the fitting can be inserted by force into another nozzle in order to be able to coat other fasteners.

The invention is not limited to the device described as an example and, in particular, the plug can comprise a connection for becoming attached to the nozzle or can comprise ridges instead of an external threading.

The device according to the invention is easy to manufacture, inexpensive and not likely to block, unlike the device of the prior art.

1. Device for applying pasty material comprising a material supply finting (1) and a coating nozzle (2), characterised in that the finting comprises a pasty material supply channel (3) ending at a first end of the finting in a central opening (4) of the nozzle (2).

2. Device according to claim 1, characterised in that the nozzle is arranged in a bell shape around the central opening (4).

3. Device according to claim 1, characterised in that the inner surface (5) of the nozzle is a continuous surface.

4. Device according to claim 1, characterised in that the fitting (1) is capable of receiving different sizes of nozzles (2), the fitting (1) and the nozzles (2) being equipped with complementary snap-on attachment means (8, 9).

5. Device according to claim 4, characterised in that the snap-on attachment means (8, 9) comprise an annular rim (9) surrounding the first end of the fitting (1) and a circular groove (8) around the central opening (4) of the nozzle (2).

6. Device according to claim 1, characterised in that the finting comprises a second end (10) for attachment to an extruder gun (12).

7. Device according to claim 1, characterised in that it comprises a cleaning tool comprising a stripping plug (6), which is inserted into the nozzle (2), the outer surface (7) of which is adapted to adhere to the pasty material (11) once polymerised.

8. Device according to claim 7, characterised in that the outer surface (7) of the stripping plug (6) is threaded in order to adhere to the pasty material (11).

9. Method of cleaning a device according to claim 1, characterised in that:
one end (10) of the fitting (1) is connected to a compressed air outlet equipped with airtight attachment means,
compressed air is blown into the fitting so that it exerts pressure on the polymerised putty and unsticks it from the walls of the fitting and nozzle, and
the polymerised putty is removed by hand from the nozzle.

10. Method of cleaning a device according to claim 1, characterised in that the stripping plug (6) is inserted into the nozzle (2) prior to the polymerisation of the pasty material, the material is then allowed to polymerise and the material is extracted by removing the plug (6) from the nozzle.
